(19) United States
(12) Patent Application Publication
(10) Pub. No.: US 2004/0174030 A1
(43) Pub. Date: Sep. 9, 2004

(54) Explosion proof work platform

(76) Inventor: Jacques Sentenne, Repentigny (CA)

Correspondence Address: E. F. & Co, 316 Knowlton Road, Lac Brome, QC, J0E 1V0, CA

(21) Appl. No.: 10/680,671

(22) Filed: Oct. 7, 2003

(30) Foreign Application Priority Data
Oct. 7, 2002 (CA) 2,406,918

(51) Int. Cl. E06C 1/00

(52) U.S. Cl. 296/24.3

(57) ABSTRACT

An explosion proof vehicle which has an elevating work platform for use in dangerous environments, the vehicle having a base, a plurality of wheels mounted on and supporting the base, a scissor arm assembly mounted on the base with a drive assembly for raising and lowering the scissor arm assembly, a work platform mounted on top of the scissor arm assembly, an explosion proof compartment mounted on the base and having a plurality of batteries mounted therein

### FIELD OF THE INVENTION

The present invention relates generally to an elevating platform and more particularly, relates to a work platform utilizing scissor type linkage.

### BACKGROUND OF THE INVENTION

Aerial work platforms are well known in the art and generally comprise a wheel base, which is normally self-propelled, and a platform which may be raised or lowered to the base by means of scissor type linkage arms. Typically, these scissor type arms are hydraulically powered to be moved between a folded lowered position to an extended raised position with the work platform being varied as desired by the operator.

Such elevating work platforms are widely used in industry and are widely regarded as a necessity for many situations.

To-date, their use has been precluded in certain situations and in particular, those situations wherein a potentially hazardous atmosphere can exist. Thus, many industrial plants utilize hazardous materials such as solvents which always present the risk of explosion. In such environments, the use of elevating work platforms has been restricted. To-date, there is no design of an elevating work platform which is approved for use as an explosion proof device.

### SUMMARY OF THE INVENTION

Accordingly, it is an object of the present invention to provide an elevating work platform of the scissor lift type which is designed to work in an explosion proof environment.

According to one aspect of the present invention, there is provided an explosion proof vehicle comprising a base, a plurality of wheels mounted on and supporting the base, a scissor arm assembly mounted on the base, scissor arm drive means for raising and lowering the scissor arm assembly, a work platform mounted on top of the scissor arm assembly, a vehicle drive means operatively connected to at least one of the plurality of wheels, and an explosion proof compartment mounted on the base and a plurality of batteries mounted in the explosion proof compartment

It is a further object of the present invention to provide an elevating work platform of the scissor lift type which is suitable to work in an environment as defined by CSA standard 22.10, Class 1, Division 1, Group D.

The elevating work platform of the present invention must, in addition to meeting the above requirements for operating in an explosion proof environment, have all the standard capabilities of such equipment. It must have systems which prevent the emission of sparks such as command systems, mechanical joints, braking systems, motor/pump systems, solenoid valves, electrical connections and wiring, batteries and their connections, etc.

Naturally, when the platform is operative and moving from one place to another, one must ensure that any possible contact with surrounding structures does not provoke any electrical discharge. Thus, preferably, one utilizes aluminum elements and may cover, as desired, any surfaces with electrically insulating coverings.

The electrical, mechanical, hydraulic and conventional security systems of the equipment must be designed to eliminate any possible sources of explosion while retaining their functionality. In order to ensure the same, one may use an anti-explosion box or container which will hold all the elements capable of producing an electrical discharge and/or a high temperature. The interior of the anti-explosion box must be ventilated while the batteries charge to ensure that there is no explosive vapour inside the box.

### BRIEF DESCRIPTION OF THE DRAWINGS

Having thus generally described the invention, reference will be made to the accompanying drawings illustrating an embodiment thereof, in which:

FIG. 1a contains two side elevational views of the platform according to the present invention;

FIG. 1b is an elevational view thereof;

FIG. 1c is a top plan view of the elevating platform;

FIG. 2 is a schematic view illustrating the principal components of the apparatus;

FIG. 3 is a schematic view of the hydraulic system; and

FIG. 4 is a schematic view of the electrical system.

### DESCRIPTION OF THE PREFERRED EMBODIMENTS

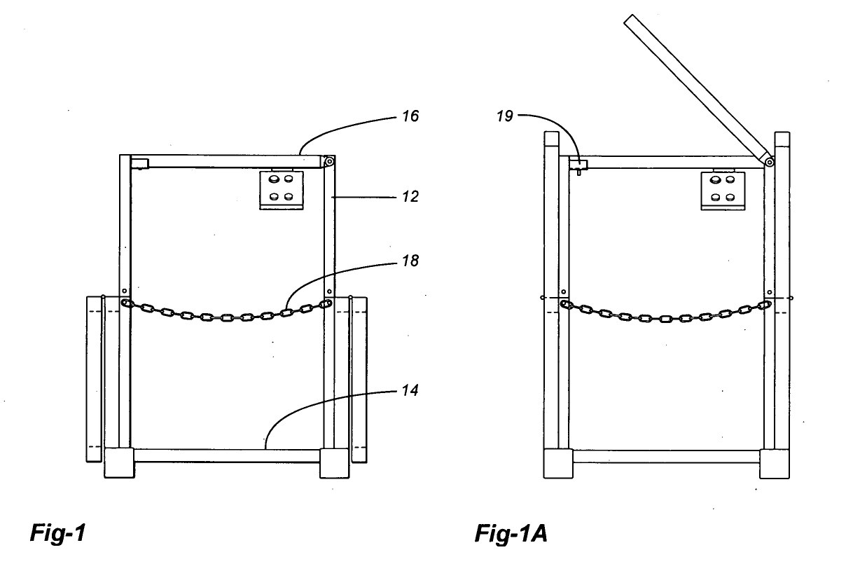

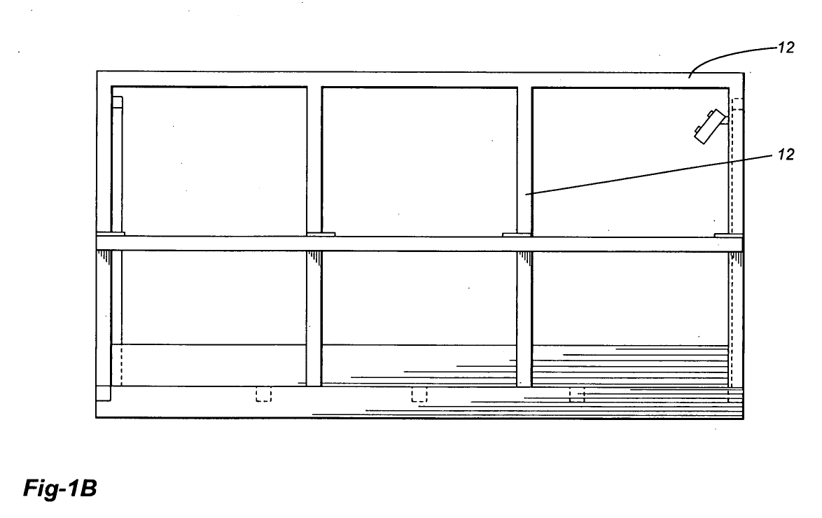

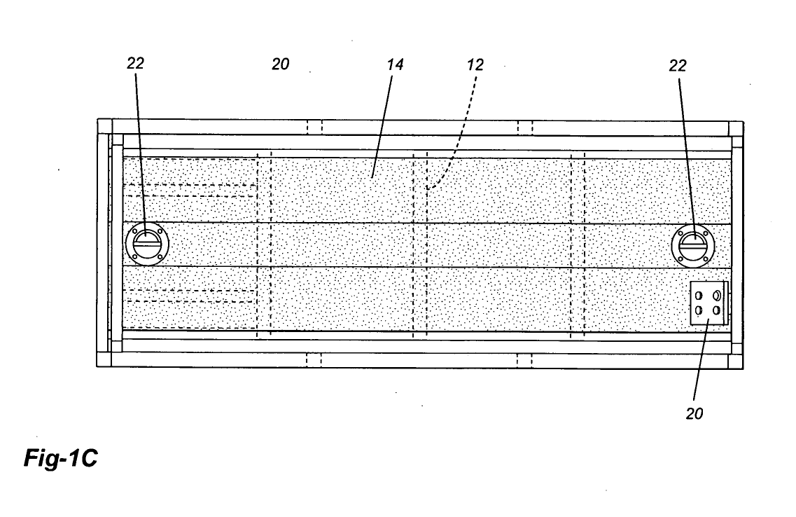

Referring to the drawings in greater detail and by reference characters thereto, the elevating platform includes a plurality of frame members generally designated by reference numeral 12 and which frame members are preferably formed of a suitably dimensioned aluminum tubing. A floor plate 14 also formed of aluminum is provided. A pivotal member 16 includes a locking device 19 while a chain member 18 extends across the platform. As may be seen in FIG. 1c, a pair of anchor points 22 are provided within floor plate 14 and which anchor points 22 are preferably formed of a stainless steel material.

As may be seen in FIG. 2, the elevating platform includes the platform and anchor points generally designated by reference numeral 24. An upper control post is generally designated by reference numeral 26. A pair of access ladders 28 are provided at either end. There is also provided a bottom control post which is generally designated by reference numeral 30.

The apparatus includes a plurality of scissor arms and sliding wear pads which are generally designated by reference numeral 32 as well as the four wheel and tire assemblies designated by reference numeral 34. A pair of drive motors 36 are associated with the left rear and right rear wheel and tire assemblies.

In any explosion or explosion proof enclosure, generally designated by reference numeral 38, enclosed is the motor/pump 40 which has associated therewith a thermal overload protector 44. A hydraulic filter 42 is provided therein. A ground supply cable 46 is enclosed in a high density thermic insulation. There are also provided solenoid valves 48 which are two way On/Off poppet valves having a high pressure capacity. A hydraulic reservoir is designed to be geometrically compatible with the available space for the equipment.

Mounted within explosion proof container 38 are a plurality of rechargeable batteries 54.

A hydraulic cylinder 52 is provided for lifting the platform in a conventional manner. In conjunction with the above, there is provided an arrangement generally designated by reference numeral 56 which provides a system permitting the lowering of the platform in case of an emergency (manual descent). Reference numeral 58 indicates jacks which are provided with height insulating material against impact. A plurality of receptacles and plugs (not shown) are provided. A housing ventilation 60 is provided.

The steering is connected to the front wheels and would include common linkage with a steering cylinder assembly operative to turn the wheel in the desired direction.

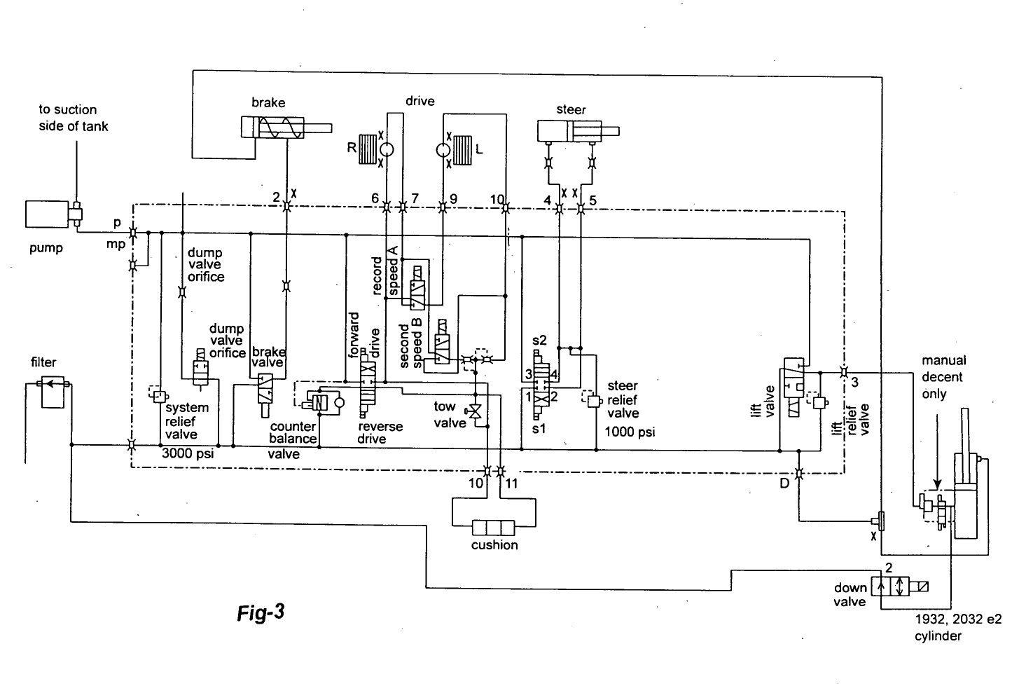

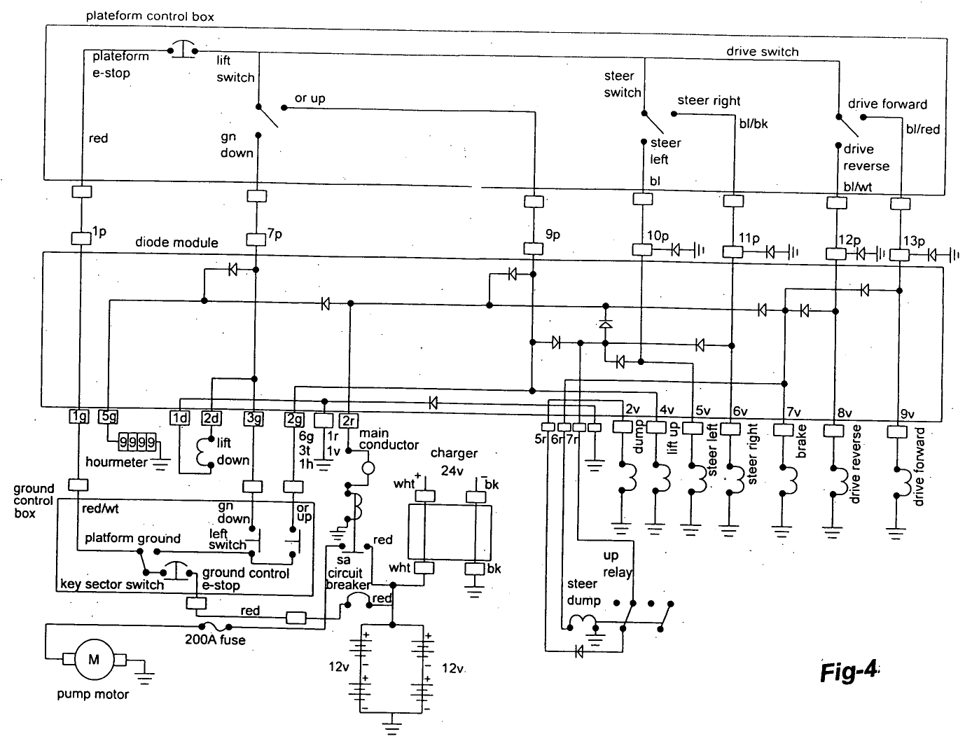

The hydraulic and electrical circuits are shown in FIGS. 3 and 4 respectively and use conventional symbols for the various components.

There are two sets of controls for operation of the vehicle. A first set will be located at ground level and will preferably comprise a selector button to determine which set of controls is operative. The only other control would be for raising and lowering of the scissor arm assembly and as well, an emergency stop button.

Located on the work form would be a second set of controls which would include those for steering and powering the vehicle, a directional button for forward and reverse, and a control for operating the scissor arm assembly. In addition, there would be the standard emergency stop button.

In other words, the working platform control station permits the operator to drive and steer the vehicle in both forward and reverse directions and raise and lower the platform. The ground control station can override the platform control station and is generally to be used only for pre-operational check and an emergency to lower the platform to the ground should the operator on the platform be unable to do so.

The vehicle is powered using hydraulic motors and cylinders. The hydraulic components are controlled by electrically activated hydraulic valves using switches and control levers.

Preferably, the vehicle is a two way drive machine with drive power being supplied by a hydraulic motor for each drive wheel. The braking is preferably arranged such that the rear wheels are supplied with spring applied hydraulically released brakes. The brakes are automatically applied anytime the drive controller is returned to neutral position.

The controls are also preferably supplied with a power selected switch which functions direct battery power to the desired control station. When this switch is in the ground position, battery power is supplied to the emergency stop switch at the ground control station. When the switch is in the platform position, battery power is supplied to the emergency stop switch at the platform control station. There is an off position for the power select switch which would be utilized when the vehicle is not operative.

It will be understood that the above described embodiment is for purposes of illustration only and that changes and modifications may be made thereto without departing from the spirit and scope of the invention.

I claim:

1. An explosion proof vehicle comprising:
a base;
a plurality of wheels mounted on and supporting said base;
a scissor arm assembly mounted on said base, scissor arm drive means for raising and lowering said scissor arm assembly;
a work platform mounted on top of said scissor arm assembly;
a vehicle drive means operatively connected to at least one of said plurality of wheels; and
an explosion proof compartment mounted on said base, and a plurality of batteries mounted in said explosion proof compartment.

2. The vehicle of claim 1 wherein said explosion proof compartment includes ventilation means.

3. The vehicle of claim 1 further including first and second control means operatively connected to said scissor arm drive means and to said vehicle drive means, said first control means being located on said platform and said second control means being located on said base.

4. The vehicle of claim 1 further including ladder means located at either end of said base.

5. The vehicle of claim 1 wherein said vehicle has a pair of front wheels and a pair of rear wheels, said vehicle drive means comprising first and second motors connected respectively to first and second rear wheels.
